(19) United States
(12) Patent Application Publication
(10) Pub. No.: US 2024/0114601 A1
(43) Pub. Date: Apr. 4, 2024

(54) INDUCTION HEATING TYPE COOKTOP AND OPERATING METHOD THEREOF

(71) Applicant: LG ELECTRONICS INC., Seoul (KR)

(72) Inventors: Hojae SEONG, Seoul (KR); Dooyong OH, Seoul (KR); Oksun YU, Seoul (KR); Seungbok OK, Seoul (KR); Byeongwook PARK, Seoul (KR)

(73) Assignee: LG ELECTRONICS INC., Seoul (KR)

(21) Appl. No.: 18/270,354

(22) PCT Filed: Feb. 3, 2021
(86) PCT No.: PCT/KR2021/001414

§ 371 Date: Jun. 29, 2023

(30) Foreign Application Priority Data
Dec. 30, 2020 (KR) 10-2020-0187881

(51) Int. Cl. H05B 6/06; H05B 6/12

(52) U.S. Cl. CPC H05B 6/062; H05B 6/1236; H05B 2213/04; H05B 2213/05; H05B 2213/07

(57) ABSTRACT

An induction cooktop includes an upper plate glass on which a cooking container is placed, a working coil generating a magnetic field to heat the cooking container, an inverter driven to flow a current through the working coil, an impedance calculation unit calculating the impedance of the cooking container on the basis of a parameter of the inverter, and an overheated state determination unit determining whether the cooking container is overheated, based on the impedance.

### CROSS-REFERENCE TO RELATED APPLICATIONS

This application is the National Phase of PCT International Application No. PCT/KR2021/001414, filed on Feb. 3, 2021, which claims priority to and the benefit of Patent Application No. 10-2020-0187881 filed in the Republic of Korea on Dec. 30, 2020, all of which are hereby expressly incorporated by reference into the present application.

### TECHNICAL FIELD

The present disclosure relates to an induction-type heating cooktop.

### BACKGROUND ART

Various types of cooking appliances are used to heat food at home or in the restaurant. According to the related art, a gas stove using gas as a fuel has been widely used. However, recently, devices for heating an object to be heated, for example, a cooking container such as a pot, have been spread using electricity instead of the gas.

A method for heating the object to be heated using electricity is largely divided into a resistance heating method and an induction heating method. The electrical resistance method is a method for heating an object to be heated by transferring heat generated when electric current flows through a metal resistance wire or a non-metal heating body such as silicon carbide to the object to be heated (e.g., a cooking container) through radiation or conduction. In the induction heating method, when high-frequency power having a predetermined intensity is applied to a coil, eddy current is generated in the object to be heated using magnetic fields generated around the coil so that the object to be heated is heated.

Recently, most of the induction heating methods are applied to cooktops. This induction heating type cooktop provide various functions for user convenience. For example, in the induction heating type cooktop, when a temperature of a cooking container rapidly rises, thermal fuse is activated to prevent damage to the cooktop due to overheating. However, when the thermal fuse operates once, the thermal fuse may not be reused and needs to be replaced. Thus, the cooktop has the inconvenience of having to be serviced in order to operate again.

In addition, international publication application WO 2017/018589A1, which is a prior art document, discloses a configuration that cuts off power by detecting a case in which a temperature of the container rises excessively. However, there are disadvantages in that an additional magnetic sensor and pad are required to detect a situation in which the temperature of the container rises excessively, and starting noise occurs because power is repeatedly supplied and cut off at predetermined cycles.

In addition, Korean registered patent KR 10-1364123B1, which is a prior art document, discloses a configuration that cuts off power supplied to a controller when overheating or failure occurs. However, there are disadvantages in that, since an earth leakage circuit breaker and a relay are added, costs increase, a circuit becomes complicated, and various elements are malfunctioned due to noise.

Therefore, there is a need for a method capable of detecting an overheating state of the container without additional components such as an expensive sensor.

### SUMMARY OF THE DISCLOSURE

An object of the present disclosure for solving the above problems is to provide an induction heating type cooktop and an operating method thereof.

An object of the present disclosure is to provide an induction heating type cooktop capable of detecting an overheating state of a cooking container capable of detecting an overheating state of a cooking container without additional components and an operating method thereof.

An object of the present disclosure is to provide an induction heating type cooktop that minimizes an operation of a thermal fuse by rapidly detecting an overheating state of a cooking container and an operating method thereof.

An object of the present disclosure is to provide an induction heating type cooktop capable of detecting an overheating state of a cooking container regardless of a material of the cooking container and an operating method thereof.

An induction heating type cooktop and an operating method thereof according to an embodiment of the present disclosure intend to detect an overheating state of a cooking container using an electrical parameter.

An induction heating type cooktop and an operating method thereof according to an embodiment of the present disclosure intend to cut off power by first detecting an overheating state of a cooking container before activating a thermal fuse.

An induction heating type cooktop and an operating method thereof according to an embodiment of the present disclosure intend to apply different criteria for recognizing a cooking container in an overheating state in consideration of characteristics of each material of the cooking container.

### Advantageous Effects

According to the embodiment of the present disclosure, since the components such as the expensive sensors are not required to detect the overheating state of the cooking container, the overheating state of the cooking container may be more sensitively detected without adding the manufacturing cost.

In addition, since the overheating state of the cooking container is first detected, and the power is cut off before the thermal fuse operates, the user inconvenience due to the thermal fuse operation may be minimized.

In addition, since the criterion for determining the overheating state of the cooking container is applied differently for each material of the cooking container, there may be the advantage in minimizing the problem of hastily determining the overheating state or determining the overheating state too late depending on the material.

Further scope of applicability of the invention will become apparent from the detailed description given hereinafter. However, it should be understood that the detailed description and specific examples, while indicating embodiments of the invention, are given by way of illustration only, since various changes and modifications within the scope of the invention will become apparent to those skilled in the art from this detailed description.

### BRIEF DESCRIPTION OF THE DRAWINGS

The present invention will become more fully understood from the detailed description given hereinbelow and the accompanying drawings which are given by way of illustration only, and thus are not limitative of the present invention.

FIG. 1 is a perspective view illustrating a cooktop and a cooking container according to an embodiment of the present disclosure.

FIG. 2 is a cross-sectional view illustrating the cooktop and the cooking container according to an embodiment of the present disclosure.

FIG. 3 is a circuit diagram of the cooktop according to an embodiment of the present disclosure.

FIG. 4 is a view illustrating output characteristics of the cooktop according to an embodiment of the present disclosure.

FIG. 5 is a view illustrating an example of measuring a relationship between an actual temperature of the cooking container and a measured temperature detected by a sensor in the induction heating type cooktop.

FIG. 6 is a view illustrating an example of measuring a relationship between an impedance of the cooking container and an actual temperature of the cooking container in the cooktop according to an embodiment of the present disclosure.

FIG. 7 is a graph illustrating a load inductance calculated together when the graph illustrated in FIG. 6 is measured.

FIG. 8 is a control block diagram of the induction heating type cooktop according to an embodiment of the present disclosure.

FIG. 9 is a flowchart illustrating an operating method of the cooktop according to a first embodiment of the present disclosure.

FIG. 10 is a flowchart illustrating an operating method of the cooktop according to a second embodiment of the present disclosure.

FIG. 11 is a flowchart illustrating an operating method of the cooktop according to a third embodiment of the present disclosure.

### DETAILED DESCRIPTION OF THE EMBODIMENTS

Hereinafter, embodiments relating to the present disclosure will be described in detail with reference to the accompanying drawings. Furthermore, terms, such as a “module” ad a “unit”, are used for convenience of description, and they do not have different meanings or functions in themselves.

Advantages and features of the present disclosure, and a method of achieving the advantages and features will become apparent with reference to embodiments described later in detail together with the accompanying drawings. However, the present disclosure is not limited to the embodiments as disclosed under, but may be implemented in various different forms. Thus, these embodiments are set forth only to make the present disclosure complete, and to completely inform the scope of the present disclosure to those of ordinary skill in the technical field to which the present disclosure belongs.

Hereinafter, an induction heating type cooktop and an operation method thereof according to an embodiment of the present disclosure will be described. For convenience of description, the “induction heating type cooktop” is referred to as a “cooktop”.

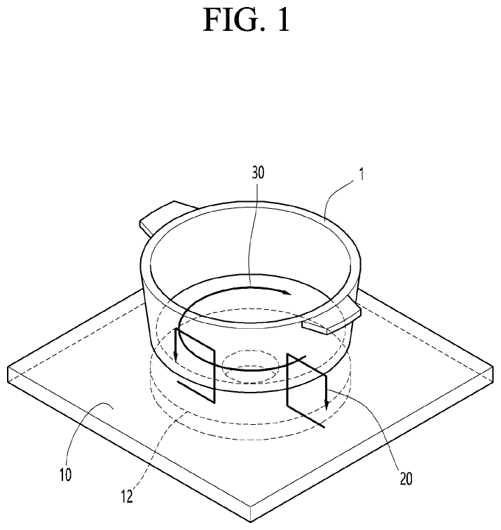

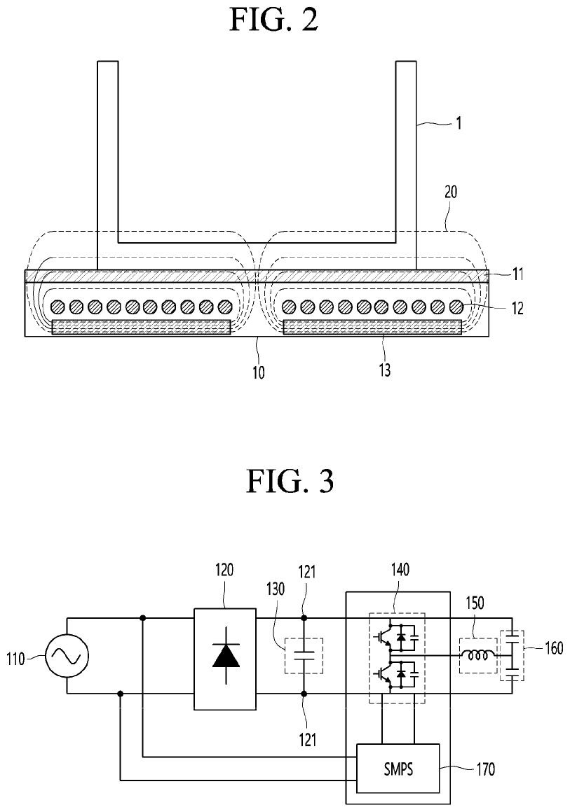

FIG. 1 is a perspective view illustrating a cooktop and a cooking container according to an embodiment of the present disclosure, and FIG. 2 is a cross-sectional view illustrating the cooktop and the cooking container according to an embodiment of the present disclosure.

A cooking container 1 may be disposed above a cooktop 10 (e.g., induction cooktop), and the cooktop 10 may heat a cooking container 1 disposed thereon. The cooking container 1 can contain a ferrous metal, such as carbon steel, cast iron, enameled, stainless steel, or any known material having high magnetic permeability, and cooking container 1 can have a thickness in a predetermined range to allow for proper current flow from the cooktop 10 to the cooking container 1. The cooktop 10 can include a heat-proof glass ceramic top surface above a coil of wire, such as copper wire, and the wire can have a low radio frequency alternating electric current passing through it to result in an oscillating electromagnetic field that induces an electrical current in the cooking container. A large eddy current flowing through a resistance of the metal in the base of the cooking container 1 can result in resistive heating.

First, a method for heating the cooking container 1 using the cooktop 10 will be described.

As illustrated in FIG. 1, the cooktop 10 can generate a magnetic field 20 so that at least a portion of the magnetic field 20 passes through the cooking container 1. Here, if an electrical resistance component is contained in a material of the cooking container 1, the magnetic field 20 can induce an eddy current 30 in the cooking container 1. Since the eddy current 30 generates heat in the cooking container 1 itself, and the heat is conducted or radiated up to the inside of the cooking container 1, contents of the cooking container 1 can be cooked.

When the material of the cooking container 1 does not contain the electrical resistance component, the eddy current 30 does not occur. Thus, in this instance, the cooktop 10 may not heat the cooking container 1.

As a result, the cooking container 1 capable of being heated by the cooktop 10 can be a stainless steel vessel or a metal vessel, such as an enamel or cast iron vessel.

Next, a method for generating the magnetic field 20 by the cooktop 10 will be described.

As illustrated in FIG. 2, the cooktop 10 can include at least one of an upper plate glass 11, a working coil 12, or a ferrite 13.

The upper plate glass 11 can support the cooking container 1. That is, the cooking container 1 can be placed on a top surface of the upper plate glass 11. That is, the upper plate glass can have a predetermined thickness to support the cooking container 1.

In addition, the upper plate glass 11 can be made of ceramic tempered glass obtained by synthesizing various mineral materials. Thus, the upper plate glass 11 can protect the cooktop 10 from an external impact.

In addition, the upper plate glass 11 can prevent foreign substances such as dust from being introduced into the cooktop 10.

The working coil 12 can be disposed below the upper plate glass 11. Current can or may not be supplied to the working coil 12 to generate the magnetic field 20. Specifically, the current can or may not flow through the working coil 12 according to on/off of an internal switching element of the cooktop 10.

When the current flows through the working coil 12, the magnetic field 20 can be generated, and the magnetic field 20 can generate the eddy current 30 by meeting the electrical resistance component contained in the cooking container 1. The eddy current can heat the cooking container 1, and thus, the contents of the cooking container 1 can be cooked.

In addition, heating power of the cooktop 10 can be adjusted according to an amount of current flowing through the working coil 12. As a specific example, as the current flowing through the working coil 12 increases, the magnetic field 20 can be generated more, and thus, since the magnetic field passing through the cooking container 1 increases, the heating power of the cooktop 10 can increase.

The ferrite 13 is a component for protecting an internal circuit of the cooktop 10. Specifically, the ferrite 13 serves as a shield to block an influence of the magnetic field 20 (e.g., block electromagnetic interference (EMI)) generated from the working coil 12 or an electromagnetic field generated from the outside on the internal circuit of the cooktop 10.

For this, the ferrite 13 can be made of a material having very high permeability. The ferrite 13 serves to induce the magnetic field introduced into the cooktop 10 to flow through the ferrite 13 without being radiated. The movement of the magnetic field 20 generated in the working coil 12 by the ferrite 13 can be as illustrated in FIG. 2.

The cooktop 10 can further include components other than the upper glass 11, the working coil 12, and the ferrite 13 described above. For example, the cooktop 10 can further include an insulator between the upper plate glass 11 and the working coil 12. That is, the cooktop according to the present disclosure is not limited to the cooktop 10 illustrated in FIG. 2.

FIG. 3 is a circuit diagram of the cooktop according to an embodiment of the present disclosure.

Since the circuit diagram of the cooktop 10 illustrated in FIG. 3 is merely illustrative for convenience of description, the embodiment of the present disclosure is not limited thereto.

Referring to FIG. 3, the induction heating type cooktop can include at least some or all of a power supply 110, a rectifier 120, a direct current (DC) link capacitor 130, an inverter 140, a working coil 150, a resonance capacitor 160, and an switched-mode power supply (SMPS) 170. The rectifier 120 can be connected in parallel to the DC link capacitor 130, and can be connected in parallel to power supply 110.

The power supply 110 can receive external power. Power received from the outside to the power supply 110 can be alternating current (AC) power.

The power supply 110 can supply an AC voltage to the rectifier 120.

The rectifier 120 is an electrical device for converting alternating current into direct current. The rectifier 120 converts the AC voltage supplied through the power supply 110 into a direct current (DC) voltage. The rectifier 120 can supply the converted voltage to both DC ends 121 (e.g., nodes, ends 121 of the DC output of the rectifier 120).

An output terminal of the rectifier 120 can be connected to both the DC ends 121. Each of both the ends 121 of the DC output through the rectifier 120 can be referred to as a DC link. A voltage measured at each of both the DC ends 121 is referred to as a DC link voltage.

A DC link capacitor 130 serves as a buffer between the power supply 110 and the inverter 140. That is, the DC link capacitor 130 can stabilize voltage distributed between the power supply 110 and the inverter 140, as known in the art. Specifically, the DC link capacitor 130 is used to maintain the DC link voltage converted through the rectifier 120 to supply the DC link voltage to the inverter 140.

The inverter 140 serves to switch the voltage applied to the working coil 150 so that high-frequency current flows through the working coil 150. The inverter 140 drives the switching element constituted by insulated gate bipolar transistors (IGBTs) to allow high-frequency current to flow through the working coil 150, and thus, a high-frequency magnetic field is generated in the working coil 150.

In the working coil 150, current can or may not flow depending on whether the switching element is driven. When current flows through the working coil 150, magnetic fields are generated. The working coil 150 can heat an cooking appliance by generating the magnetic fields as the current flows.

One side (e.g., a first side) of the working coil 150 is connected to a connection point of the switching element of the inverter 140, and the other side (e.g., a second side) is connected to the resonance capacitor 160.

The switching element is driven by a driver, and a high-frequency voltage is applied to the working coil 150 while the switching element operates alternately by controlling a switching time output from the driver. In addition, since a turn on/off time of the switching element applied from the driver is controlled in a manner that is gradually compensated, the voltage supplied to the working coil 150 is converted from a low voltage into a high voltage.

The resonance capacitor 160 can be a component to serve as a buffer. The resonance capacitor 160 controls a saturation voltage increasing rate during the turn-off of the switching element to affect an energy loss during the turn-off time.

The SMPS 170 (switching mode power supply) refers to a power supply that efficiently converts power according to a switching operation. The SMPS 170 converts a DC input voltage into a voltage that is in the form of a square wave and then obtains a controlled DC output voltage through a filter. That is, the SMPS 170 can convert voltage and current characteristics and continually switches between low-dissipation, full-on and full-off states, where voltage regulation is achieved by varying the ratio of on-to-off time (also known as duty cycles). The SMPS 170 can minimize an unnecessary loss by controlling a flow of the power using a switching processor.

In the case of the cooktop 10 expressed by the circuit diagram illustrated in FIG. 3, a resonance frequency is determined by an inductance value of the working coil 150 and a capacitance value of the resonance capacitor 160. Then, a resonance curve can be formed around the determined resonance frequency, and the resonance curve can represent output power of the cooktop 10 according to a frequency band.

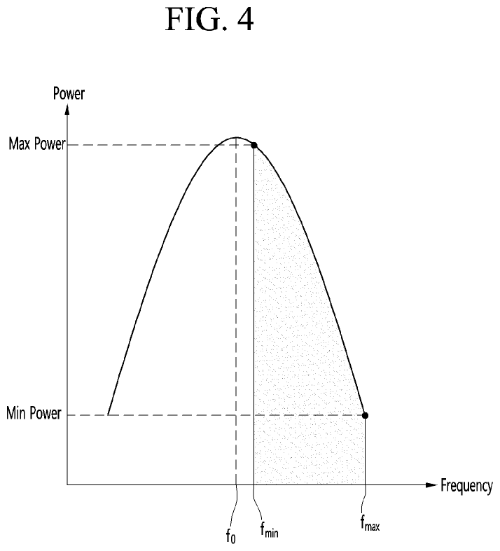

Next, FIG. 4 is a view illustrating output characteristics of the cooktop according to an embodiment of the present disclosure.

First, a Q factor (quality factor) can be a value representing sharpness of resonance in the resonance circuit. Therefore, in the case of the cooktop 10, the Q factor is determined by the inductance value of the working coil 150 included in the cooktop 10 and the capacitance value of the resonant capacitor 160. The resonance curve can be different depending on the Q factor. Thus, the cooktop 10 has different output characteristics according to the inductance value of the working coil 150 and the capacitance value of the resonant capacitor 160.

FIG. 4 illustrates an example of the resonance curve according to the Q factor. In general, the larger the Q factor, the sharper the shape of the curve, and the smaller the Q factor, the broader the shape of the curve.

A horizontal axis of the resonance curve can represent a frequency, and a vertical axis can represent output power (e.g., in watt (W)). A frequency at which maximum power is output in the resonance curve is referred to as a resonance frequency f₀.

In general, the cooktop 10 uses a frequency in a right region based on the resonance frequency f₀ of the resonance curve. In addition, the cooktop 1 can have a minimum operating frequency and a maximum operating frequency, which are set in advance.

For example, the cooktop 10 can operate at a frequency corresponding to a range from the maximum operating frequency fₘₐₓ to the minimum operating frequency fₘᵢₙ. That is, the operating frequency range of the cooktop 10 can be from the maximum operating frequency fₘₐₓ to the minimum operating frequency fₘᵢₙ.

For example, the maximum operating frequency fₘₐₓ can be a maximum switching frequency of an insulated-gate bipolar transistor (IGBT) of the inverter 140. The IGBT maximum switching frequency can mean a maximum driving frequency in consideration of a resistance voltage and capacity of the IGBT switching element. For example, the maximum operating frequency fₘₐₓ can be 75 kHz.

The minimum operating frequency fₘᵢₙ can be about 20 kHz. In this instance, since the cooktop 10 does not operate at an audible frequency (about 16 Hz to 20 kHz), noise of the cooktop 10 can be reduced.

Since setting values of the above-described maximum operating frequency fₘₐₓ and minimum operating frequency fₘᵢₙ are only examples, the embodiment of the present disclosure is not limited thereto.

When receiving a heating command, the cooktop 10 can determine an operating frequency according to a heating power level set by the heating command. Specifically, the cooktop 10 can adjust the output power by decreasing in operating frequency as the set heating power level is higher and increasing in operating frequency as the set heating power level is lower. That is, when receiving the heating command, the cooktop 10 can perform a heating mode in which the cooktop operates in one of the operating frequency ranges according to the set heating power.

The cooking container 1 heated by the cooktop 10 can be divided into a plurality of states. As specific examples, the plurality of states can be classified into a heating state in which a temperature of the water (or food) inside the cooking container 1 constantly increases, a boiling state in which the temperature of the water (or food) inside the cooking container 1 is maintained, and an overheating state with no water (or food) inside the cooking container 1.

Here, the overheating state means a state in which there is no water (or food) inside the cooking container 1, and when the cooktop 10 continuous to heat the cooking container 1 that is in the overheating state, a risk of fire is very high. Thus, the cooktop 10 can detect the overheating state of the cooking container 1 to cut off power.

For this, the cooktop 10 can distinguish the states of the cooking container 1 being heated.

According to an embodiment, the cooktop 10 can distinguish the states of the cooking container 1 according to the temperature of the cooking container 1, and for this, a sensor (e.g., temperature sensor) for detecting the temperature of the cooking container 1 can be further provided, which is provided as known the art. That is, one of ordinary skill in the art would recognize that the temperature sensor can be disposed on any portion of the cooktop 10. For instance, the sensor can be generally disposed on an upper plate glass 11 in order to be in contact with the cooking container. The sensor can have a very slow response speed, and thus, the cooktop 1 has a disadvantage in that it is difficult to immediately determine that the cooking container 1 becomes the overheating state.

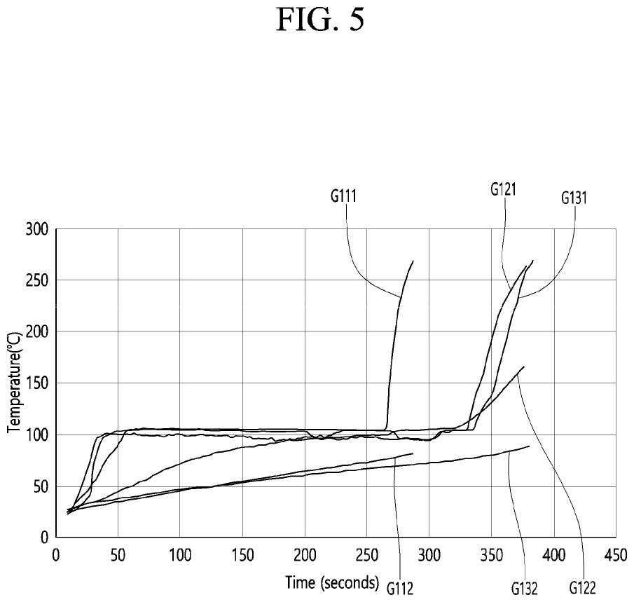

FIG. 5 is a view illustrating an example of measuring a relationship between an actual temperature of the cooking container and a measured temperature detected by the sensor in the induction heating type cooktop.

FIG. 5 illustrates graphs G111, G121, and G131 showing actual temperatures of the cooking container 1 for three types of cooking containers made of different materials and graphs G112, G122, and G132 showing measured temperatures detected by the sensor (temperature sensor).

First, the first-1 graph G111 can show an actual temperature of a first cooking container and the first-2 graph G112 can show a measured temperature of the first cooking container, which is detected by the sensor. Referring to the first-1 graph G111, it is seen that a period of about 0 second to about 30 seconds is a section in which the temperature rises primarily and means that the cooking container is in a heating state, a period of about 30 seconds to about 270 seconds is a section in which the temperature is maintained and means that the cooking container is in a boiling state, and a period of about 270 seconds or more is a section in which the temperature is rises secondarily and means that the cooking container is in an overheating state. However, referring to the first-2 graph G112, the measured temperature of the sensor is steadily increasing up to a temperature of about 270 seconds, and the measured temperature of the sensor is still at about 80 degrees at about 270 seconds, and as a result, it is confirmed that it is difficult to determine the overheating state of the cooking container based on the temperature measured by the sensor.

Similarly, the second-1 graph G121 can show an actual temperature of a second cooking container and the second-2 graph G122 can show a measured temperature of the second cooking container, which is detected by the sensor. Referring to the second-1 graph G121, it is seen that a period of about 0 second to about 50 seconds is a section in which the temperature rises primarily and means that the cooking container is in a heating state, a period of about 50 seconds to about 330 seconds is a section in which the temperature is maintained and means that the cooking container is in a boiling state, and a period of about 330 seconds or more is a section in which the temperature is rises secondarily and means that the cooking container is in an overheating state. However, referring to the second-2 graph G122, although the measured temperature of the sensor increases somewhat rapidly from about 330 seconds, and the actual temperature of the cooking container reaches 270 degrees at about 370 seconds, the measured temperature of the sensor is still only about 170 degrees, and thus, it is confirmed that it is difficult to determine the overheating state of the cooking container with the measured temperature of the sensor.

Finally, the 3-1 graph G131 can show an actual temperature of a third cooking container and the 3-2 graph G132 can show a measured temperature of the third cooking container, which is detected by the sensor. Referring to the 3-1 graph (G131), it is seen that a period of about 0 second to about 30 seconds is a section in which the temperature rises primarily and means that the cooking container is in a heating state, a period of about 30 seconds to about 330 seconds is a section in which the temperature is maintained and means that the cooking container is in a boiling state, and a period of about 330 seconds or more is a section in which the temperature is rises secondarily and means that the cooking container is in an overheating state. However, referring to the 3-2 graph G132, the measured temperature of the sensor does not rapidly change until about 370 seconds, and the actual temperature of the cooking container at about 370 seconds reaches 270 degrees. However, since the temperature measured by the sensor is still only about 80 degrees, it is confirmed that it is difficult to determine the overheating state of the cooking container at the temperature measured by the sensor.

As described above, when using the sensor for detecting the temperature of the cooking container, there is a limit in that it is difficult to react more sensitively to the overheating state of the cooking container, and even if it is assumed that the overheating state of the cooking container is quickly detected through a more sensitive sensor, in this instance, there is a problem in that the cost increases because the sensor is expensive. That is, a temperature sensor may not be able to detect an overheating state of the cooking container, and thus, the present disclosure seeks to better determine an overheating state of the cooking container.

Thus, the cooktop 10 according to the embodiment of the present disclosure intends to determine the overheating state of the cooking container 1 using an electrical parameter without adding additional components. In particular, the cooktop 10 according to an embodiment of the present disclosure intends to determine the overheating state of the cooking container 1 using an impedance or inductance of the cooking container 1, which are calculated through the parameter of the inverter 140. Here, the impedance Z means a degree of obstruction to a flow of current in an AC system in which the concept of resistance R and the concept of phase generated by an inductor and capacitor are combined in a frequency region, and the inductance L means an amount of counter electromotive force generated in a coil expressed as a change rate of current.

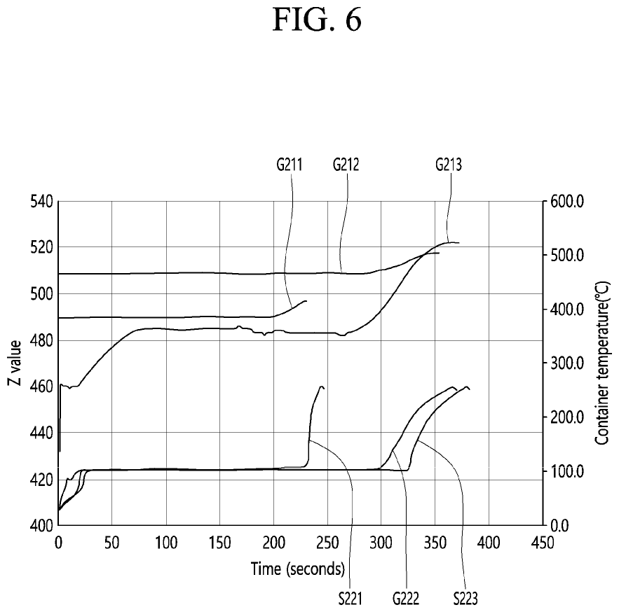

Next, FIG. 6 is a view illustrating an example of measuring a relationship between an impedance of the cooking container and an actual temperature of the cooking container in the cooktop according to an embodiment of the present disclosure.

First, referring to FIG. 6, FIG. 6 illustrates impedance graphs G211, G212, and G213 of the cooking container 1 for three cooking containers made of different materials and actual temperature graphs G221, G222, and G223 showing an actual temperature of the cooking container 1.

First, referring to the first impedance graph G211, the impedance of the first cooking container is maintained at a constant value until about 200 seconds and then increases from about 200 seconds. In addition, referring to the actual temperature graph G221 of the first cooking container, the first cooking container enters the overheating state from about 230 seconds.

Next, referring to the second impedance graph G212, the impedance of the second cooking container is maintained at a constant value until about 300 seconds and then increases from about 300 seconds. In addition, referring to the actual temperature graph G222 of the second cooking container, the second cooking container enters the overheating state from about 300 seconds.

Finally, referring to the third impedance graph G213, the impedance of the third cooking container increases from about 260 seconds. In addition, referring to the actual temperature graph G223 of the third cooking container, the third cooking container enters the overheating state from about 330 seconds.

That is, according to the impedance graph and the actual temperature graph of the first to third cooking containers, it is confirmed that the impedance of the cooking container increases at or before the cooking container enters the overheating state.

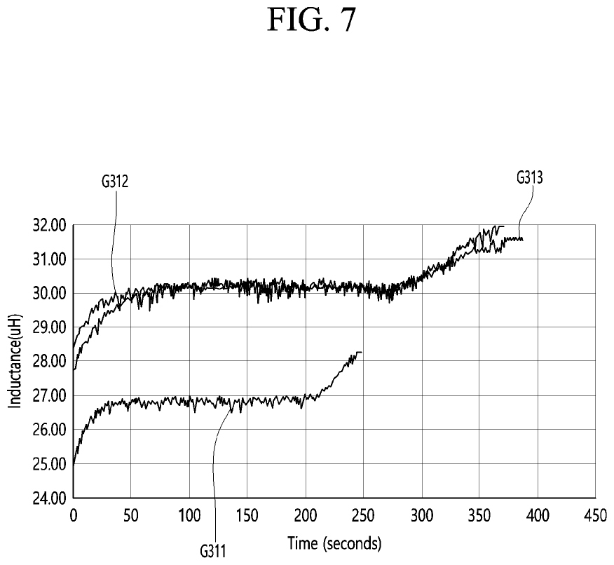

In addition, FIG. 7 is a graph illustrating a load inductance calculated together when the graph illustrated in FIG. 6 is measured.

Referring to FIG. 7, a first inductance graph G311 represents an inductance of the first cooking container and shows an increase from about 210 seconds. In addition, as reviewed in FIG. 6, referring to the actual temperature graph G221 of the first cooking container, the first cooking container enters the overheating state from about 230 seconds.

In addition, the second inductance graph G312 represents an inductance of the second cooking container and shows an increase from about 270 seconds. In addition, as reviewed in FIG. 6, referring to the actual temperature graph G222 of the second cooking container, the second cooking container enters the overheating state from about 300 seconds.

In addition, the third inductance graph G313 represents an inductance of the third cooking container and shows an increase from about 270 seconds. In addition, as reviewed in FIG. 6, referring to the actual temperature graph G223 of the third cooking container, the third cooking container enters the overheating state from about 330 seconds.

That is, according to the inductance graph and the actual temperature graph of the first to third cooking containers, it is confirmed that the inductance of the cooking container increases at or before the cooking container enters the overheating state.

In summary, it is seen that the impedance and inductance of the cooking container 1 increase before the actual temperature of the cooking container 1 increases. Thus, the cooktop 10 according to an embodiment of the present disclosure can determine the overheated state of the cooking container 1 using at least one of the impedance or inductance of the cooking container 1, and in determining that the cooking container 1 is in an overheated state, the cooktop 10 can be controlled to be turned off or to reduce the supplied electromagnetic field (by reducing a current flowing through the cooktop) to regulate the temperature of the cooking container 1 to a desired temperature, for example, such that the contents within the cooking container maintain a boiled state, or maintain a predetermined temperature.

For convenience of description, in the present disclosure, it is assumed that the cooktop 10 detects the overheating state of the cooking container 1 using the impedance of the cooking container 1. However, this is merely an example for convenience of explanation, and hereinafter, the impedance of the cooking container 1 can be replaced by the inductance of the cooking container 1.

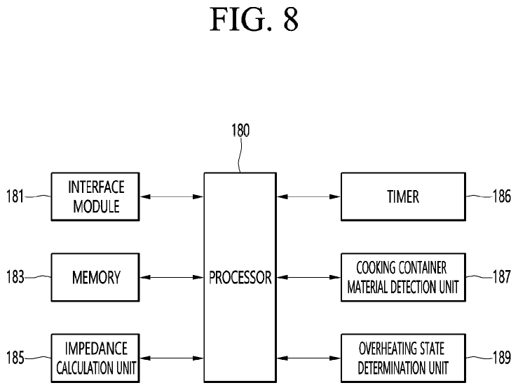

FIG. 8 is a control block diagram of the induction heating type cooktop according to an embodiment of the present disclosure.

The induction heating type cooktop 10 according to an embodiment of the present disclosure includes at least a portion or all of a processor 180, an interface module 181, a memory 183, an impedance calculation unit 185, a timer 186, a cooking container material detection unit 187, and an overheating state determination unit 189. The processor 180 can comprise all of the interface module 181, a memory 183, the impedance calculation unit 185, a timer 186, a cooking container material detection unit 187, and the overheating state determination unit 189.

According to embodiments, the cooktop 10 can omit some of the above-described components or can further include other components. That is, the components illustrated in FIG. 8 are merely examples for describing the cooktop 10 according to an embodiment of the present disclosure.

The processor 180 can control the cooktop 10. The processor 180 can include each of the interface module 181, the memory 183, the impedance calculation unit 185, the timer 186, the cooking container material detection unit 187, the overheating state determination unit 189, which are illustrated in FIG. 8, and the power supply 110, the rectifier 120, the DC link capacitor 130, the inverter 140, the working coil 150, the resonance capacitor 160, and the SMPS 170, which are illustrated in FIG. 3.

The interface module 181 can receive a user input. The interface module 181 can have a physical key button or be implemented in the form of a touch screen to receive the user input. For example, the interface module 181 can receive a heating command for starting a heating mode, a heating power selection command for adjusting heating power, and the like.

The memory 183 can store data related to an operation of the cooktop 10. For example, the memory 183 can store data in which the impedance for distinguishing the overheating state for each material of the cooking container is mapped. As a specific example, the memory 183 can store data in which a first impedance for distinguishing a first material and a cooking container made of the first material in the overheating state is mapped, and a second impedance for distinguishing a second material and a cooking container made of the second material in the overheating state is mapped, . . . , an Nth impedance for distinguishing an Nth material and the cooking container made of the Nth material in an overheating state is mapped.

The impedance calculation unit 185 can calculate the impedance of the cooking container 1 currently being heated. The impedance calculation unit 185 can calculate the impedance of the cooking container 1 through a parameter of the inverter 140.

Following equation is an example of an equation in which the impedance calculation unit 185 calculates the impedance Z of the cooking container 1.

$$Z = \frac{\sqrt{2}}{π} * \frac{{V}_{in}}{{I}_{rms}} \qquad [ Equation 1 ]$$

Where Iᵣₘₛ can be a resonant current, and Vin can be an input voltage.

In addition, the impedance calculation unit 185 can calculate the inductance of the cooking container 1 currently being heated.

Following equation is an example of an equation in which the impedance calculation unit 185 calculates the inductance of the cooking container 1.

$$\to \frac{1}{ω} \sqrt{\frac{2}{{π}^{2}} \frac{{V}_{in}^{2}}{{I}_{rms}^{2}} - {R}_{eq}^{2}} + \frac{1}{{ω}^{2} {C}_{eq}} \qquad [ Equation 2 ]$$

$${L}_{eq} = \frac{1}{ω} \sqrt{\frac{2 {V}_{in}^{2}}{{π}^{2} {P}_{O}} \cdot {R}_{eq} - {R}_{eq}^{2}} + \frac{1}{{ω}^{2} {C}_{eq}} \qquad [ Equation 3 ]$$

$$\to \frac{1}{ω} \sqrt{{Z}^{2} - {R}_{eq}^{2}} + \frac{1}{{ω}^{2} {C}_{eq}} \qquad [ Equation 4 ]$$

The impedance calculation unit 185 can calculate the impedance or inductance of the cooking container 1 using the above-described equation L_{eq} is the inductance of cooking container 1, ω is the operating frequency, Pₒ is the output power and C_{eq} is the capacitance value of the resonance capacitor 160.

In addition, the impedance calculation unit 185 can further calculate a slope of the impedance through the calculated impedance. For example, the impedance calculation unit 185 can calculate an impedance slope at a predetermined time period (e.g., 1 second) while calculating the impedance at a predetermined time period (e.g., 1 second). Specifically, the impedance calculation unit 185 can calculate an impedance slope by calculating a difference between a first calculated impedance and a (1+M)th calculated impedance for every predetermined time, and calculate a difference between a second calculated impedance and a (2+M)th calculated impedance, . . . , a difference between an N-th calculated impedance and an (N+M)-th calculated impedance. Here, since an impedance calculation period, an impedance slope calculation period, an M value, etc. are merely examples, it is reasonable not to be limited thereto.

The timer 186 can count a time taken to heat the cooking container 1. That is, the timer 186 can count an operating time in the heating mode in which the cooking container 1 is heated.

The cooking container material detection unit 187 can detect a material of the cooking container 1 currently being heated. For example, the cooking container material detection unit 187 can detect whether the cooking container 1 currently being heated is made of a first material, a second material, . . . , or an Nth material.

According to an embodiment, the cooking container material detection unit 187 can detect the material of the cooking container 1 currently being heated based on a preset cooking container material determination algorithm.

According to another embodiment, the cooking container material detection unit 187 can detect the impedance of the cooking container 1 immediately upon starting the heating mode, and the material of the cooking container 1 currently being heated through the detected initial impedance (e.g., initial impedance value).

The above-described embodiments are merely examples, and the cooking container material detection unit 187 can detect the material of the cooking container 1 currently being heated in various manners, such as by using a camera and a database of known materials.

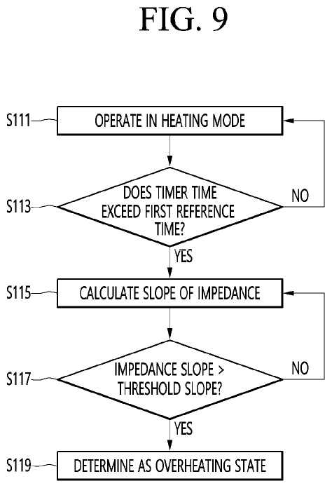

According to embodiments, the cooktop 10 can not include the cooking container material detection unit 187. For example, the cooktop 10 operating as illustrated in FIG. 9 to be described later may not include the cooking container material detection unit 187.

The overheating state determination unit 189 can determine whether the cooking container 1 is in the overheating state based on the impedance calculated by the impedance calculating unit 185. Specifically, the overheating state determination unit 189 can determine whether the cooking container 1 is in the overheating state using at least one of the impedance and the impedance slope.

Next, an operating method of the cooktop 10 according to an embodiment of the present disclosure will be described.

FIG. 9 is a flowchart illustrating an operating method of the cooktop according to a first embodiment of the present disclosure.

First, a cooktop 10 can operate in a heating mode (S111).

When receiving a heating command through an interface module 181, a processor 180 can operate in the heating mode. The processor 180 can control an inverter 140 and a working coil 150 when operating in the heating mode, and thus, the inverter 140 can be driven so that current flows through the working coil 150, and the working coil 140 can generate a magnetic field so that the cooking container 1 is heated.

Also, the processor 180 can control the timer 186 to count an operating time in the heating mode while operating in the heating mode. Thus, the timer 186 can count the operating time in the heating mode. Hereinafter, the timer time means the operating time in the heating mode counted by the timer 186.

The processor 180 can determine whether the timer time exceeds a first reference time (S113).

When the timer time does not exceed the first reference time, the processor 180 can control the heater to continuously operate in the heating mode.

The first reference time can mean a minimum time required to calculate a slope of an impedance. Specifically, referring to the first to third impedance graphs G211, G212, and G213 of FIG. 6, the first impedance graph G211 can start to increase from about 200 seconds, and the second impedance graph G212 can start to increase from about 300 seconds, and the third impedance graph G213 can start to increase from about 270 seconds. In this case, the first reference time can be about 300 seconds.

As described above, the cooktop 10 determines the overheating state after determining whether the first reference time elapses, thereby minimizing errors occurring when determining the overheating state using the impedance slope calculated before the first reference time elapses.

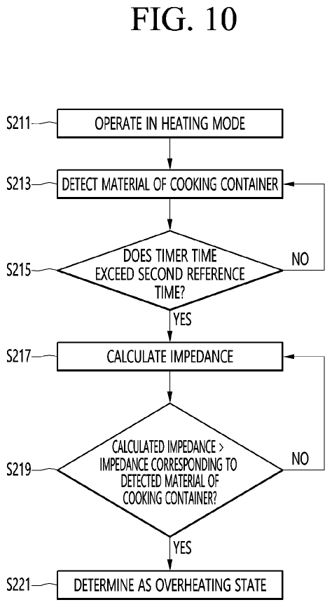

However, this is merely exemplary, and the first reference time can be changed according to the performance of the cooktop 10 and the like. In addition, since the term ‘first’ in the ‘first reference time’ is merely a term used to be distinguished from the ‘second reference time’ of FIG. 10, it is reasonable not to be limited thereto.

As described above, the cooktop 10 according to an embodiment of the present disclosure can determine the overheating state when the timer time exceeds the first reference time, and thus, the detection speed can be slightly slower because the first reference time is longer than the second reference time. However, since it is based on the slope of the impedance, there is an advantage in that the accuracy of determining the overheating state is improved.

The processor 180 can calculate the slope of the impedance when the timer time exceeds the first reference time (S115).

That is, the processor 180 can control the impedance calculation unit 185 to calculate the slope of the impedance when the timer time exceeds the first reference time.

The method for calculating the slope of the impedance by the impedance calculation unit 185 has been described with reference to FIG. 8, and duplicate descriptions will be omitted.

After calculating the slope of the impedance, the processor 180 can determine whether the calculated slope of the impedance is greater than a threshold slope (S117).

That is, the processor 180 can control the overheating state determination unit 189 to determine whether the calculated impedance slope is greater than the threshold slope. The overheating state determination unit 189 can determine an overheating state based on an impedance slope when an operating time in the heating mode for heating the cooking container exceeds the first reference time.

The threshold slope can be a value that distinguishes an impedance slope of the cooking container in a boiling state and an impedance slope of the cooking container in an overheating state and can be a value that is preset when the cooktop 10 is manufactured through experimental values previously measured for cooking containers.

The processor 180 can control the impedance calculation unit 185 to continuously calculate the impedance slope when the impedance slope is less than or equal to the threshold slope.

In addition, the overheating state determination unit 189 can determine the overheating state when the slope of the impedance is greater than the threshold slope (S119).

The processor 180 can eliminate the heating mode when the overheating state determination unit 189 determines that the cooking container 1 is in the overheating state. Alternatively, the processor 180 can turn off the power when the overheating state determination unit 189 determines that the cooking container 1 is in the overheating state.

As illustrated in FIG. 9, when the cooktop 10 determines the overheating state of the cooking container 1 using the slope of the impedance, there has an advantage in that the overheating of the cooking container 1 is determined without knowing the material of the cooking container 1 being heated. That is, the cooktop 10 has an advantage of being able to determine an overheating state of the cooking container 1 regardless of the type and amount of load of the cooking container 1.

FIG. 10 is a flowchart illustrating an operating method of the cooktop according to a second embodiment of the present disclosure.

A cooktop 10 can operate in a heating mode (S211).

Since this is the same as operation S111 of FIG. 9, redundant description will be omitted.

A processor 180 can detect a material of a cooking container (S213).

That is, the processor 180 can control a cooking container material detection unit 187 to detect the material of the cooking container 1 currently being heated. The operation S213 of detecting the material of the cooking container can be performed after operation S215 or operation S217 to be described later. That is, the order of operation S213 can be changed. Upon detecting the material of the cooking container 1 currently being heated, the processor can control the heating of the cooking container based on the determined material.

The processor 180 can determine whether a timer time exceeds a second reference time (S215).

Since the timer time is the same as that described above with reference to FIG. 9, redundant description will be omitted.

When the timer time does not exceed the second reference time, the processor 180 can control to continuously operate in a heating mode.

The second reference time can refer to a minimum time required for an impedance to reach a steady state after an inverter 140 starts an operation thereof. For example, the cooking container being heated by the cooktop 10 can be a cooking container that is heated in a completely cooled state (e.g., from a state where a temperature of the cooking container is substantially equal to the ambient temperature, or from a cooled state where the temperature of the cooking container is less than the ambient temperature), or in some cases, the cooking container can be a cooking container that is heated to a certain extent and then stopped and then heated again. In the above two cases, the impedance of the cooking container calculated immediately upon starting the heating mode can be different from each other, and an error can occur when determining the overheating state based on the thus calculated impedance. Thus, the cooktop 10 can minimize the error in determining the overheating state by using the impedance calculated after the second reference time required for the impedance to reach a steady state elapses. This second reference time can be changed according to performance of the cooktop 10 and the like. In addition, since the term ‘second’ in the ‘second reference time’ is only a term used to be distinguished from the ‘first reference time’ of FIG. 9, it is reasonable not to be limited thereto. However, the second reference time is less than the first reference time of FIG. 9.

When the timer time exceeds the second reference time, the processor 180 can calculate the impedance (S217).

That is, the processor 180 can control the impedance calculation unit 185 to calculate the impedance when the timer time exceeds the second reference time.

The method for calculating the impedance by the impedance calculation unit 185 has been described with reference to FIG. 8, and thus, redundant description will be omitted.

The processor 180 can determine whether the calculated impedance is greater than the impedance corresponding to the detected material of the cooking container (S219).

That is, the processor 180 can control an overheating state determination unit 189 to determine whether the calculated impedance is greater than the impedance corresponding to the detected material of the cooking container. The overheating state determination unit 189 can determine the overheating state based on the impedance when an operating time in the heating mode for heating the cooking container exceeds the second reference time. In addition, when the material of the cooking container is detected, the overheating state determination unit 189 can determine the overheating state using an impedance when the operating time in the heating mode for heating the cooking container exceeds the second reference time.

Here, the impedance corresponding to the detected material of the cooking container can be a value extracted from the memory 183. Thus, the processor 180 can detect the material of the cooking container, extract the impedance corresponding to the material of the cooking container detected in the memory 183, and compare the impedance calculated by the impedance calculating unit 185 with the impedance.

The processor 180 can control the impedance calculation unit 185 to continuously calculate the impedance when the calculated impedance is less than or equal to the impedance corresponding to the detected material of the cooking container.

The overheating state determination unit 189 can determine the overheating state when the calculated impedance is greater than the impedance corresponding to the detected material of the cooking container (S221).

That is, the overheating state determination unit 189 can determine the overheating state when the impedance of the cooking container is greater than the impedance corresponding to the detected material of the cooking container.

Since this is the same as that described in step S119 of FIG. 9, redundant description will be omitted.

On the other hand, as described in FIG. 10, when the cooktop 10 compares the impedance to determine the overheating state of the cooking container 1, there is an advantage in that the cooking container 1 more quickly determines the overheating state because the second reference time is shorter than the first reference time.

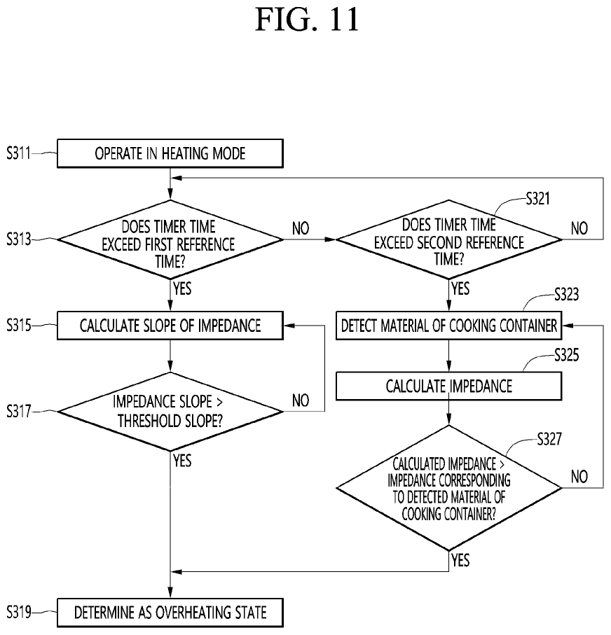

FIG. 11 is a flowchart illustrating an operating method of the cooktop according to a third embodiment of the present disclosure.

FIG. 11 illustrates an operation method combining the operation method according to FIG. 9 and the operation method according to FIG. 10. Thus, descriptions overlapping with those described in FIGS. 9 and 10 will be omitted.

A cooktop 10 can operate in a heating mode (S311).

While operating in the heating mode, a processor 180 can determine whether a timer time exceeds a first reference time (S313).

When the timer time exceeds the first reference time, the processor 180 can calculate a slope of an impedance (S315).

After calculating the slope of the impedance, the processor 180 can compare the slope of the impedance with a threshold slope (S317).

If the slope of the impedance is less than or equal to the threshold slope, the processor 180 can continuously calculate the slope of the impedance (S315).

When the slope of the impedance is greater than the threshold slope, the processor 180 can determine the overheating state (S319).

When the timer time is equal to or less than the first reference time, the processor 180 can determine whether the timer time exceeds the second reference time (S321).

When the timer time does not exceed the second reference time, the processor 180 can continue to operate in the heating mode and perform (e.g., re-perform) operation S313.

When the timer time exceeds the second reference time, the processor 180 can detect the material of the cooking container (S323) and calculate the impedance of the cooking container (S325), for example, immediately upon starting the heating mode.

The processor 180 can compare the calculated impedance with the impedance corresponding to the detected material of the cooking container (S327).

The processor 180 continues to calculate the impedance when the calculated impedance is less than or equal to the impedance corresponding to the material of the detected cooking container (S325), and if the calculated impedance is greater than the impedance corresponding to the material of the detected cooking container, the processor 180 can determine the state as the overheating state (S319).

According to FIG. 11, when an operating time in the heating mode for heating the cooking container exceeds the first reference time, the overheating state determination unit 189 can determine the overheating state based on the slope of the impedance, and when the operating time in the heating mode for heating the cooking container is less than the first reference time, the overheating state can be determined based on the impedance. Particularly, when the operating time in the heating mode for heating the cooking container is less than the first reference time and exceeds the second reference time less than the first reference time, the overheating state can be determined based on impedance.

According to the operating method illustrated in FIG. 11, the cooktop 10 has the advantage of being able to more quickly and accurately determine the overheating state of the cooking container by using the impedance according to the timer time.

In addition, according to the methods shown in FIGS. 9 to 11, since the cooktop 10 does not require the components such as the expensive sensors to detect the overheated state of the cooking container, the overheated state of the cooking container can be more sensitively detected without adding the manufacturing cost. In addition, since the cooktop 10 detects the overheated state of the cooking container first, and the power is cut off before the thermal fuse operates, the user inconvenience due to the thermal fuse operation can be minimized. In addition, since the criterion for determining the overheating state of the cooking container is applied differently for each material of the cooking container, there can be the advantage in minimizing the problem of hastily determining the overheating state or determining the overheating state too late depending on the material.

The above-disclosed subject matter is to be considered illustrative, and not restrictive, and the appended claims are intended to cover all such modifications, enhancements, and other embodiments, which fall within the true spirit and scope of the present disclosure.

Thus, the embodiment of the present disclosure is to be considered illustrative, and not restrictive, and the technical spirit of the present disclosure is not limited to the foregoing embodiment.

Therefore, the scope of the present disclosure is defined not by the detailed description of the invention but by the appended claims, and all differences within the scope will be construed as being included in the present disclosure.

Various embodiments described herein may be implemented in a computer-readable medium using, for example, software, hardware, or some combination thereof. For example, the embodiments described herein may be implemented within one or more of Application Specific Integrated Circuits (ASICs), Digital Signal Processors (DSPs), Digital Signal Processing Devices (DSPDs), Programmable Logic Devices (PLDs), Field Programmable Gate Arrays (FPGAs), processors, controllers, micro-controllers, microprocessors, other electronic units designed to perform the functions described herein, or a selective combination thereof. In some cases, such embodiments are implemented by the controller. For Example, the controller is a hardware-embedded processor executing the appropriate algorithms (e.g., flowcharts) for performing the described functions and thus has sufficient structure. Also, the embodiments such as procedures and functions may be implemented together with separate software modules each of which performs at least one of functions and operations. The software codes can be implemented with a software application written in any suitable programming language. Also, the software codes can be stored in the memory and executed by the controller, thus making the controller a type of special purpose controller specifically configured to carry out the described functions and algorithms. Thus, the components shown in the drawings have sufficient structure to implement the appropriate algorithms for performing the described functions.

For a software implementation, the embodiments such as procedures and functions may be implemented together with separate software modules each of which performs at least one of functions and operations. The software codes can be implemented with a software application written in any suitable programming language. Also, the software codes may be stored in the memory and executed by the controller. Thus, the components shown in the drawings have sufficient structure to implement the appropriate algorithms for performing the described functions.

The present invention encompasses various modifications to each of the examples and embodiments discussed herein. According to the invention, one or more features described above in one embodiment or example can be equally applied to another embodiment or example described above. The features of one or more embodiments or examples described above can be combined into each of the embodiments or examples described above. Any full or partial combination of one or more embodiment or examples of the invention is also part of the invention.

1-10. (canceled)

11. An induction cooktop, comprising:
an upper plate glass configured to receive a cooking container;
a working coil configured to generate a magnetic field so as to heat the cooking container;
an inverter configured to be driven to allow current to flow through the working coil; and
a processor configured to:
calculate an impedance of the cooking container based on a parameter of the inverter; and
determine whether the cooking container is in an overheated state based on the calculated impedance.

12. The induction cooktop according to claim 11, wherein the processor is further configured to:
calculate a slope of the impedance; and
determine the overheated state in response to the slope of the impedance being greater than a threshold slope.

13. The induction cooktop according to claim 12, wherein the processor is further configured to determine the overheated state based on the slope of the impedance, in response to an operating time in a heating mode for heating the cooking container exceeding a first reference time.

14. The induction cooktop according to claim 11, wherein the processor is further configured to:
detect a material of the cooking container; and
determine the overheated state in response to the impedance of the cooking container being greater than a predetermined impedance corresponding to the detected material of the cooking container.

15. The induction cooktop according to claim 14, further comprising non-transitory memory configured to store data in which an impedance for distinguishing an overheated state for each predetermined material of the cooking container is mapped.

16. The induction cooktop according to claim 14, wherein the processor is further configured to determine the overheated state based on the impedance, in response to an operating time in a heating mode for heating the cooking container exceeding a second reference time.

17. The induction cooktop according to claim 11, wherein the processor is further configured to:
determine the overheated state based on a slope of the impedance, in response to an operating time in a heating mode for heating the cooking container exceeding a first reference time; and
determine the overheated state based on the impedance, in response to the operating time in the heating mode for heating the cooking container being less than the first reference time.

18. The induction cooktop according to claim 17, wherein the processor is further configured to determine the overheated state based on the impedance, in response to the operating time in the heating mode for heating the cooking container being less than the first reference time and exceeding a second reference time, the second reference time being less than the first reference time.

19. The induction cooktop according to claim 11, wherein the processor is further configured to:
detect a material of the cooking container based on an impedance of the cooking container, immediately upon starting a heating mode for heating the cooking container; and
determine the overheated state using the impedance, in response to an operating time in the heating mode exceeding a second reference time.

20. An operating method of an induction cooktop, the induction cooktop including an inverter, a working coil, and an upper plate, the operating method comprising:
disposing a cooking container on the upper plate;
driving the inverter to allow current to flow through the working coil;
heating the cooking container by a magnetic field generated in the working coil;
calculating an impedance of the cooking container based on one or more parameters of the inverter while the cooking container is heated; and
determining whether the cooking container is in an overheated state based on the impedance.

21. The operating method of claim 20, further comprising reducing the magnetic field generated in the working coil or turning off the cooktop, in response to determining the cooking container is in the overheated state.

22. The operating method of claim 21, wherein the reducing the magnetic field generated in the working coil includes controlling heating of the cooking container to maintain a constant value.

23. The operating method of claim 21, wherein the determining whether the cooking container is in the overheated state includes:
calculating a slope of the impedance over time; and
determining the cooking container as being in the overheated state if the slope of the impedance is greater than a threshold slope.

24. The operating method of claim 23, wherein the slope of the impedance is calculated only after a first reference time, and
wherein the threshold slope is a value corresponding to a change from a boiling state to the overheated state.

25. The operating method of claim 24, further comprising determining a material of the cooking container based on the impedance of the cooking container before the first reference time and after a second reference time, the second reference time being less than the first reference time.

26. The operating method of claim 20, wherein the impedance of the cooking container is calculated after detecting the material of the cooking container, and
wherein the method further comprises determining that the cooking container is in the overheated state in response to the calculated impedance being greater than a predetermined impedance corresponding to the detected material of the cooking container.

27. The operating method of claim 20, further comprising:
determining a material of the cooking container based on the impedance of the cooking container immediately upon starting the heating of the cooking container; and
controlling the heating of the cooking container based on the determined material to maintain the cooking container at a consistent temperature.

28. An operating method of an induction cooktop, the induction cooktop including a working coil and an upper plate, the operating method comprising:
disposing a cooking container on the upper plate;
heating the cooking container by applying current to the working coil;
determining whether the cooking container is in an overheated state based on one of an inductance or an impedance of the cooking container; and
stopping heating of the cooking container or reducing heating of the cooking container in response to determining that the cooking container is in an overheated state.

29. The operating method of claim 28, wherein the determining whether the cooking container is in the overheated state includes:
calculating a slope of the inductance over time; and
determining the cooking container as being in the overheated state if the inductance slope is greater than a threshold value.

30. The operating method of claim 28, further comprising:
determining a material of the cooking container based on the inductance of the cooking container immediately upon starting the heating of the cooking container; and
controlling the heating of the cooking container based on the determined material.
